(19) United States
(12) Patent Application Publication
(10) Pub. No.: US 2015/0355807 A1
(43) Pub. Date: Dec. 10, 2015

(54) Systems and Methods For Selecting a Still Image From a Live Video Feed

(71) Applicant: Telefonaktiebolaget L M Ericsson (publ), Stockholm (SE)

(72) Inventors: Patrik OLDSBERG, Tyreso (SE); Måns HOMMERBERG, Uppsala (SE)

(73) Assignee: Telefonaktiebolaget L M Ericsson (publ), Stockholm (SE)

(21) Appl. No.: 14/619,478

(22) Filed: Feb. 11, 2015

Related U.S. Application Data
(60) Provisional application No. 62/008,236, filed on Jun. 5, 2014.

(51) Int. Cl. G06F 3/0486; G06F 3/0484; G06F 17/24

(52) U.S. Cl. CPC G06F 3/0486; G06F 17/241; G06F 3/04842

(57) ABSTRACT

In one aspect, systems and methods that make it possible for a user to view a live video feed on a display while at the same time select a suitable still image from the live video feed are provided. Thus, the live video feed is not hidden from the user while the user selects the still image. In some embodiments, this advantageous feature is achieved by providing a graphical user interface (GUI) having: i) a live video view for displaying a live video feed; ii) a video snippet view for displaying a snippet of the live video feed; and iii) a still image view. A frame from the live video view or a frame from the snippet view can be dragged to the still image view. Thus, an image can be grabbed from either the snippet view or directly from the live video view.

### CROSS-REFERENCE TO RELATED APPLICATIONS

This application claims the benefit of provisional application No. 62/008,236, filed on Jun. 5, 2014, which is incorporated by reference.

### TECHNICAL FIELD

This disclosure relates to selecting a still image from a live video feed.

### BACKGROUND

Technologies have developed that allow a user who is watching a live video feed (e.g., a live TV broadcast) to rewind the live video feed and pause the video feed. For example, DIRECTV provides a service that enables its user to “pause and rewind as [they are] watching live TV.” See www(dot)directv(dot)com/technology/dvr_service. Additionally, video editing applications, such as Adobe After Effects produced by Adobe Systems, usually allow the user to scan through a video and select a still image through a button or context menu.

### SUMMARY

In some applications (e.g., remote collaboration applications) there is a need to select a suitable still image from a live video feed. The existing method of rewinding and pausing a live video find to find a suitable still images has disadvantages, such as hiding the live video from the user while the user looks for the suitable still image, which can be undesirable.

In one aspect, embodiments relate to systems and methods that make it possible for a user to view a live video feed on a display while at the same time select a suitable still image from the live video feed. Thus, the live video feed is not hidden from the user while the user selects the still image. In some embodiments this advantageous feature is achieved by providing a graphical user interface (GUI) having: i) a live video view for displaying a live video feed; ii) a video snippet view for displaying a snippet of the live video feed; and iii) a still image view. A frame from the live video view or a frame from the snippet view can be dragged to the still image view. Thus, an image can be grabbed from either the snippet view or directly from the live video view by initiating a drag and drop action. The image can then be dropped on the still image view.

Accordingly, there is provided in one aspect a computer system for selecting a still image from a live video feed. In some embodiments, the computer system includes: a data storage system; and a data processing system (DPS) coupled to the data storage system. The DPS is configured to display a graphical user interface (GUI). In some embodiments, the GUI includes: a live video view for displaying a live video feed; a video snippet view for displaying a snippet of the live video feed; and a still image view. The DPS is further configured such that, while a live video feed is being displayed in the live video view, the DPS is operable to receive a user input event indication indicating that a user has performed a user input action. The DPS is further configured such that, in response to receiving the user input event indication and while the live video feed is still being displayed, the DPS uses the video snippet view to enable the user to: i) scrub a snippet of the live video feed that has already been displayed in the live video view and ii) drag and drop a selected video frame from the snippet of the live video feed into the still image view.

In some embodiments, the DPS is further configured such that, while a live video feed is being displayed in the live video view, the user is enabled to drag and drop a video frame displayed in the live video view into the still image view.

In some embodiments, the snippet of the live video consists of video frames that were displayed in the live video view not more than X seconds prior to the DPS receiving the user input event indication.

In some embodiments, the GUI further comprises a seek button, and the user input action consists of the user activating the seek button. In some embodiments, the DPS is configured to hide the video snippet view until the user activates the seek button.

In some embodiments, the DPS is further configured to enable the user to annotate the video frame that was dragged and dropped into the still image view.

In some embodiments, the DPS is further configured to: generate a still image file containing the video frame dragged and dropped by the user into the still image view in response to the user invoking a save image command; and/or upload to another computer system the video frame dragged and dropped by the user into the still image view in response to the user invoking a send image command.

In some embodiments, the GUI includes a live video view for displaying a live video feed a still image view, but does not include the video snippet view for displaying a snippet of the live video feed. In such embodiments, the DPS is configured such that, while a live video feed is being displayed in the live video view, the DPS enables the user to select a video frame from the live video feed and the DPS displays the selected video frame in the still image view. In some embodiments, the DPS enable the user to select a video frame from the live video feed by enabling the user to drag and drop a video frame displayed in the live video view into the still image view.

In another aspect there is provided a method for selecting a still image from a live video feed. In some embodiments, the method includes receiving, at a computer system having a data storage system and a data processing system (DPS) comprising one or more processors, a live video feed transmitted by a media server. The method further includes displaying the live video feed in a live video view of a graphical user interface (GUI). The method further includes, while displaying the live video feed in the live video view of the graphical user interface, receiving a user input event indication indicating that a user has performed a user input action. The method further includes, using a video snippet view portion of the GUI to enable the user to scrub a snippet of the live video feed that has already been displayed in the live video view in response to receiving the user input event indication. The method further includes enabling the user to drag and drop a selected video frame from the snippet of the live video feed into a still image view.

In some embodiments, the method further includes enabling the user to drag and drop a video frame displayed in the live video view into the still image view while the live video feed is being displayed in the live video view of the graphical user interface.

In some embodiments, the snippet of the live video consists of video frames that were displayed in the live video view not more than X seconds prior to receiving the user input event indication (e.g., X<10 seconds). In some embodiments, X equals three seconds.

The method may further include displaying a seek button as part of the GUI, wherein the user input action consists of the user activating the seek button.

The method may further include hiding the video snippet view until the user activates the seek button.

The method may further include enabling the user to annotate the video frame that was dragged and dropped into the still image view.

The method may further include generating a still image file containing the video frame dragged and dropped by the user into the still image view in response to the user invoking a save image command.

In other embodiments, the method includes receiving, at a computer system having a data storage system and a data processing system (DPS) comprising one or more processors, a live video feed transmitted by a media server. The method may further include displaying the live video feed in a live video view of a graphical user interface (GUI). The method may further include, while displaying the live video feed in the live video view of the graphical user interface, performing the further step of: enabling the user to select a video from the live video feed; and displaying the selected video frame in the still image view.

In some embodiments, enabling the user to select a video from the live video feed comprises enabling the user to drag and drop a video frame displayed in the live video view into the still image view.

The above and other aspects and embodiments are described below.

### BRIEF DESCRIPTION OF DRAWINGS

FIG. 1 is a block diagram of a computer system according to some embodiments.

FIG. 2 illustrates an example graphical user interface (GUI) according to some embodiments.

FIG. 3 is a flow chart illustrating a process, according to some embodiments, for selecting a still image from a live video feed.

FIG. 4 is a flow chart illustrating a process, according to some embodiments, for selecting a still image from a live video feed.

### DETAILED DESCRIPTION

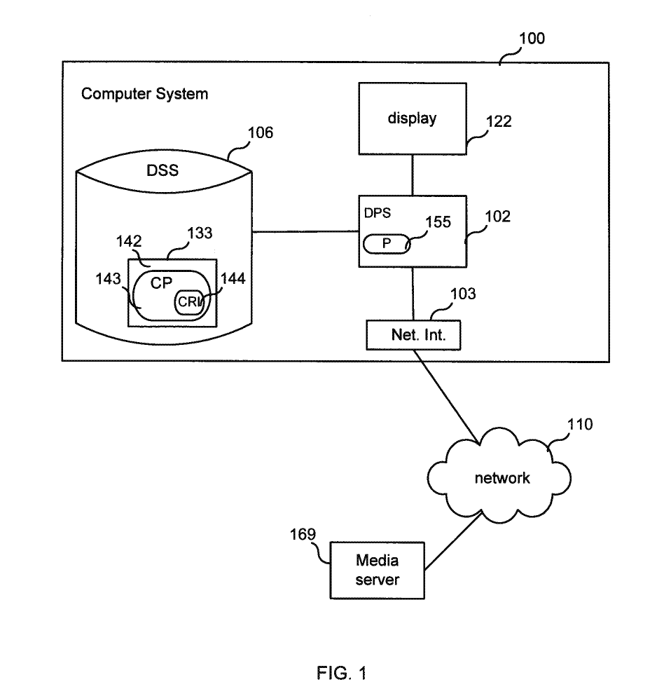

Disclosed herein are systems and methods for selecting a still image from a live video feed. Referring to FIG. 1, FIG. 1 illustrates a computer system 100 according to embodiments. As shown in FIG. 1, computer system 100 includes a data processing system (DPS) 102, which may include one or more processors 155 (e.g., a general purpose microprocessor) and/or one or more circuits, such as an application specific integrated circuit (ASIC), field-programmable gate arrays (FPGAs), and the like. Computer system 100 also includes a display 122 (e.g., a liquid crystal display (LCD) monitor, light emitting diode (LED) monitor, or other type of display device), which may be a touch sensitive display, for outputting video and still images. Computer system 100 may include a network interface 103 for use in connecting computer system 100 to a network (e.g., network 110). Computer system 100 includes a data storage system (DSS) 106, which may include one or more non-volatile storage devices and/or one or more volatile storage devices (e.g., random access memory (RAM)). Computer system 100 may be a distributed computer system (e.g., in some embodiments DPS 102 and display 122 are not co-located).

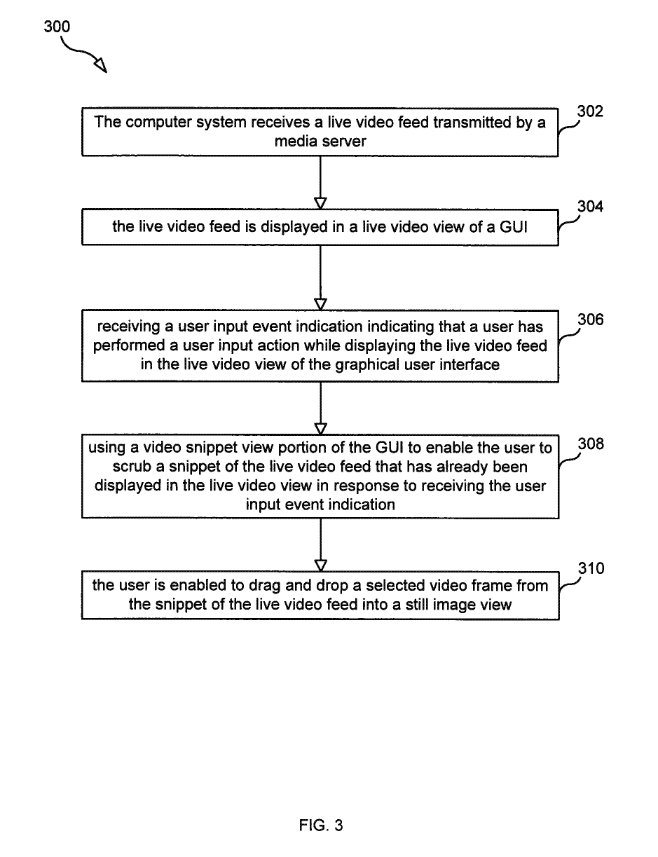

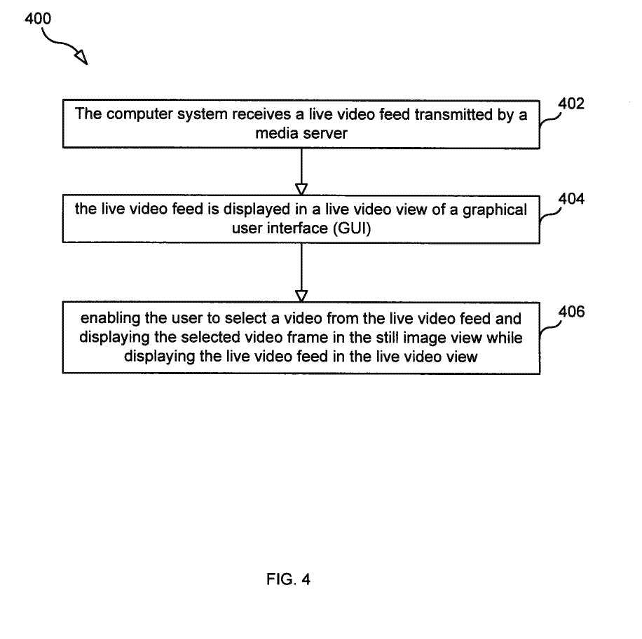

In embodiments where DPS 102 includes a processor 155, a computer program product (CPP) 133 may be provided. CPP 133 includes a computer readable medium (CRM) 142 storing a computer program (CP) 143 comprising computer readable instructions (CRI) 144. CRM 142 may be a non-transitory computer readable medium, such as, but not limited, to magnetic media (e.g., a hard disk), optical media (e.g., a DVD), memory devices (e.g., random access memory), and the like. In some embodiments, the CRI 144 of computer program 143 is configured such that when executed by DPS 102, the CRI causes the computer system 100 to perform steps described below (e.g., steps described below with reference to the flow charts shown in FIGS. 3 and 4). In other embodiments, computer system 100 may be configured to perform steps described herein without the need for code. That is, for example, DPS 102 may consist merely of one or more ASICs. Hence, the features of the embodiments described herein may be implemented in hardware and/or software.

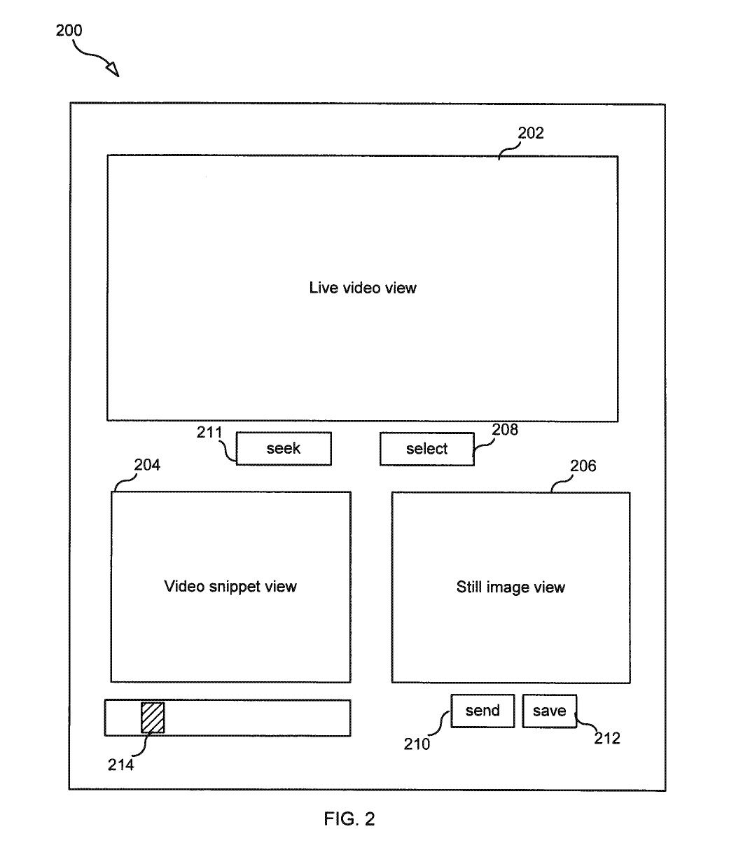

In some embodiments, DPS 102 is configured to display a graphical user interface (GUI) 200 (see FIG. 2). That is, DPS 102 generates GUI 102 and causes display 122 to display GUI 200. GUI 200 is a GUI for enabling a user to select a still image from a live video feed and to upload the select image to another computer system.

As shown in FIG. 2, GUI includes a live video view 202 for displaying a live video feed and a still image view 206. The live video feed may be received via network interface 103. For example, the live video feed may be transmitted (e.g., streamed) by a media server 169 connected to network 110 (e.g., the Internet), received by network interface 103, and decoded and displayed by DPS 102 in live video view 202. Thus, a user of computer system 100 can watch a live video feed (e.g., a live TV show such as a sporting event).

DPS 102 is further configured such that, while a live video feed is being displayed in the live video view 202, DPS 102 enables the user to select a video frame from the live video feed and then DPS 102 displays the user selected video frame in the still image view. For example, in one embodiment, a user selects a video frame by activating a select button 208 displayed as a part of GUI 200. That is, in some embodiments, when the user activates select button 208 (e.g., when the user uses a mouse to click on the button), DPS 102 displays in view 208 the video frame that was displayed in live video view 202 at the time the user activated button 208. In this way, when the user sees an image in the live video feed that the user would like to capture, the user can easily capture the image.

In another embodiment, the user selects a video frame from the live video feed by performing a drag and drop operation from live video view 202 to still image view 206. In such an embodiment, the selected video frame may be the video frame that is being displayed in view 202 at the time the drop action occurs or it may be the video that was displayed in view 202 at the time dragging operation is initiated.

In some embodiments, when the user drags and drops a video frame into still image view 206, this action triggers computer system to perform an image processing algorithm on the selected video frame, such as, for example, an image resizing and/or image encoding algorithm.

After the selected video frame is displayed in still image view 206, the user may upload the still the image displayed in still image view 206 to another computer by, for example, activating an send button 210 on GUI 200. Additionally, the user may annotate the video frame before it is uploaded such that the video frame is uploaded together with the annotations. In some embodiments, in response to the user activating send button 210, the user is prompted by DPS 102 to enter an e-mail address to which the image will be sent.

In some embodiments, after the selected video frame is displayed in still image view 206, the user may save the video frame to a file by activating a save button 212. In response to the user activating the save button 212, DPS generates a still image file containing the video frame displayed in view 206 at the time the user activated save button 212.

In some embodiments, GUI 200 further includes a video snippet view 204 for displaying a “snippet” of the live video feed—i.e., a selected sequence of the live video feed. The length of the snippet (denoted as “X”) may vary. In some embodiments, X can be set by the user and/or set dynamically based on, for example, system resources. In some embodiments X is less than 10 seconds. In one implementation, X is three seconds.

In embodiments that include a video snippet view 204, DPS 102 is further configured such that, while a live video feed is being displayed in the live video view 202, DPS 102 is operable to receive a user input event indication indicating that a user has performed a user input action. DPS 102 is further configured such that, in response to receiving the user input event indication and while the live video feed is still being displayed, DPS 102 uses the video snippet view to enable the user to: i) scrub a snippet of the live video feed that has already been displayed in the live video view 202 and ii) drag and drop a selected video frame from the snippet of the live video feed into the still image view 206.

For example, in response to the user input event indication, DPS 102 displays the video snippet in snippet view 204 and DPS 102 then allows the user to scrub the snippet by, for example, including a seek slider 214 in GUI 200. That is, the user can use the seek slider 214 to view each individual video frame that is included in the snippet of the live video feed, as is known in the art of video editing. This is sometimes referred to as “shuttling” to the desired frame.

In some embodiments, the snippet of the live video consists of video frames that were displayed in the live video view not more than X seconds prior to DPS 102 receiving the user input event indication. In some embodiments, GUI 200 further comprises a seek button 211, and the user input action consists of the user activating seek button 211.

In some embodiments, DPS 102 is configured to hide video snippet view 204 until the user perform the user input action (e.g., until the user activates seek button 211).

In some embodiments, DPS 102 is configured to allow the user to drag and drop an image from other sources to still image view 106. Such other sources include a file system and web pages.

Referring to FIG. 3, FIG. 3 is a flow chart illustrating a process 300, according to some embodiments, for selecting a still image from a live video feed.

Process 300 may begin in step 302, in which computer system 100 receives a live video feed (e.g. a live video feed transmitted by media server 169).

In step 304, computer system 100 displays the live video feed in live video view 202 of GUI 200.

While displaying the live video feed in the live video view 202 of GUI 200, computer system receives a user input event indication indicating that a user has performed a user input action (step 306).

In response to receiving the user input event indication (e.g., in direct and immediate response to receiving the indication), computer system 100 uses a video snippet view 204 portion of the GUI to enable the user to scrub a snippet of the live video feed that has already been displayed in the live video view 202 (step 308).

In step 310, computer system enables the user to drag and drop a selected video frame from the snippet view 204 into a still image view 206.

In some embodiments, the snippet of the live video consists of video frames that were displayed in the live video view not more than X seconds prior to receiving the user input event indication. Preferably X is less than 10 seconds, but in some embodiments X is greater than 10. In one specific implementation, X is three seconds. That is, in one specific implementation, the user can seek through all of the frames from the previous three seconds of the live video feed.

In some embodiments, computer system 100 further enabling the user to drag and drop a video frame displayed in the live video view 202 into the still image view while the live video feed is being displayed in the live video view 202 of GUI 200.

In some embodiments, computer system 100 further displays seek button 211 as part of GUI 209, and the user input action consists of the user activating the seek button.

In some embodiments, computer system 100 hides the video snippet view 2014 until the user activates the seek button 211.

In some embodiments, computer system 100 enables the user to annotate the video frame that was dragged and dropped into the still image view 206.

Referring to FIG. 4, FIG. 4 is a flow chart illustrating a process 400, according to other embodiments, for selecting a still image from a live video feed.

Process 400 may begin in step 402, in which computer system 100 receives alive video feed transmitted by a media server 169. In step 404, computer system displays the live video feed in a live video view 202 of GUI 200. While computer system 100 displays the live video feed in the live video view 202, computer system 100 enables the user to select a video from the live video feed and displays the selected video frame in the still image view 206 (steps 404 and 406, respectively). In some embodiments, computer system 100 enables the user to select a video from the live video feed comprises enabling the user to drag and drop a video frame displayed in the live video view into the still image view.

Advantages

An advantage with some embodiments is that they allow the user to keep viewing the live video feed while selecting an image, so that important events from the live video feed are not missed while selecting the image. A further advantage is that an intuitive drag and drop interface enables fast and streamlined image selection. A yet further advantage is that an embodiment allows for a uniform way of selecting images. Images from other sources such as file system and websites can also be dragged and dropped to the still image view.

### CONCLUSION

While various embodiments have been described above, it should be understood that they have been presented by way of example only, and not limitation. Thus, the breadth and scope of the present invention should not be limited by any of the above-described exemplary embodiments. For example, the exact layout of GUI 200 shown in FIG. 2 is just an example of how GUI 200 may look. That is, the views can be arranged differently and have different sizes than that shown in FIG. 2. In the example shown in FIG. 2, live video view 202 is given the most space, but in other embodiments, still image view 206 may be given the most space. Also, there is no limit on the number of views that may be included in GUI 200. GUI 200 could, for example, have multiple still image views, multiple live video feed views, and multiple snippet views.

Further, any combination of the above-described elements in all possible variations thereof is encompassed by this disclosure unless otherwise indicated herein or otherwise clearly contradicted by context. Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A computer system for selecting a still image from a live video feed, comprising:
a data storage system; and
a data processing system (DPS) coupled to the data storage system and configured to display a graphical user interface (GUI), said GUI comprising:
a live video view for displaying a live video feed;
a video snippet view for displaying a snippet of the live video feed; and
a still image view, wherein
the DPS is further configured such that, while a live video feed is being displayed in the live video view, the DPS is operable to receive a user input event indication indicating that a user has performed a user input action, and
the DPS is further configured such that, in response to receiving the user input event indication and while the live video feed is still being displayed, the DPS uses the video snippet view to enable the user to: i) scrub a snippet of the live video feed that has already been displayed in the live video view and ii) drag and drop a selected video frame from the snippet of the live video feed into the still image view.

2. The computer system of claim 1, wherein the DPS is further configured such that, while a live video feed is being displayed in the live video view, the user is enabled to drag and drop a video frame displayed in the live video view into the still image view.

3. The computer system of claim 1, wherein the snippet of the live video consists of video frames that were displayed in the live video view not more than X seconds prior to the DPS receiving the user input event indication.

4. The computer system of claim 1, wherein
the GUI further comprises a seek button, and
the user input action consists of the user activating the seek button.

5. The computer system of claim 4, wherein the DPS is configured to hide the video snippet view until the user activates the seek button.

6. The computer system of claim 1, wherein the DPS is further configured to enable the user to annotate the video frame that was dragged and dropped into the still image view.

7. The computer system of claim 1, wherein the DPS is further configured to:
generate a still image file containing the video frame dragged and dropped by the user into the still image view in response to the user invoking a save image command; and/or
upload to another computer system the video frame dragged and dropped by the user into the still image view in response to the user invoking a send image command.

8. A method for selecting a still image from a live video feed, comprising:
receiving, at a computer system having a data storage system and a data processing system (DPS) comprising one or more processors, a live video feed transmitted by a media server;
displaying the live video feed in a live video view of a graphical user interface (GUI); and
while displaying the live video feed in the live video view of the graphical user interface, receiving a user input event indication indicating that a user has performed a user input action;
in response to receiving the user input event indication, using a video snippet view portion of the GUI to enable the user to scrub a snippet of the live video feed that has already been displayed in the live video view; and
enabling the user to drag and drop a selected video frame from the snippet of the live video feed into a still image view.

9. The method of claim 8, further comprising enabling the user to drag and drop a video frame displayed in the live video view into the still image view while the live video feed is being displayed in the live video view of the graphical user interface.

10. The method of claim 8, wherein the snippet of the live video consists of video frames that were displayed in the live video view not more than X seconds prior to receiving the user input event indication.

11. The method of claim 8, further comprising displaying a seek button as part of the GUI, wherein the user input action consists of the user activating the seek button.

12. The method of claim 11, further comprising hiding the video snippet view until the user activates the seek button.

13. The method claim 8, further comprising enabling the user to annotate the video frame that was dragged and dropped into the still image view.

14. The method of claim 8, further comprising:
generating a still image file containing the video frame dragged and dropped by the user into the still image view in response to the user invoking a save image command; and/or
uploading to another computer system the video frame dragged and dropped by the user into the still image view in response to the user invoking a send image command

15. A computer system for selecting a still image from a live video feed, comprising:
a data storage system; and
a data processing system (DPS) coupled to the data storage system and configured to display a graphical user interface (GUI), said GUI comprising:
a live video view for displaying a live video feed; and
a still image view, wherein
the DPS is further configured such that, while a live video feed is being displayed in the live video view, the DPS enables the user to select a video frame from the live video feed and
the DPS displays the selected video frame in the still image view.

16. The computer system of claim 15, wherein the DPS enable the user to select a video frame from the live video feed by enabling the user to drag and drop a video frame displayed in the live video view into the still image view.

17. The computer system of claim 15, wherein the DPS is further configured to enable the user to annotate the video frame that was dragged and dropped into the still image view.

18. The computer system of claim 15, wherein the DPS is further configured to:
generate a still image file containing the video frame displayed in the still image view in response to the user invoking a save image command; and/or
upload to another computer system the video frame dragged and dropped by the user into the still image view in response to the user invoking a send image command

19. A method for selecting a still image from a live video feed, comprising:
receiving, at a computer system having a data storage system and a data processing system (DPS) comprising one or more processors, a live video feed transmitted by a media server;
displaying the live video feed in a live video view of a graphical user interface (GUI); and
while displaying the live video feed in the live video view of the graphical user interface, enabling the user to select a video from the live video feed, and displaying the selected video frame in the still image view.

20. The method of claim 19, wherein enabling the user to select a video from the live video feed comprises enabling the user to drag and drop a video frame displayed in the live video view into the still image view.

21. The method claim 19, further comprising enabling the user to annotate the video frame that was dragged and dropped into the still image view.

22. The method of claim 19, further comprising:
generating a still image file containing the video frame dragged and dropped by the user into the still image view in response to the user invoking a save image command; and/or
uploading to another computer system the video frame dragged and dropped by the user into the still image view in response to the user invoking a send image command
